(19) United States
(12) Patent Application Publication
(10) Pub. No.: US 2023/0386106 A1
(43) Pub. Date: Nov. 30, 2023

(54) DISPARITY IMAGE FILLING METHOD AND IMAGE PROCESSING DEVICE

(71) Applicant: SigmaStar Technology Ltd., Xiamen (CN)

(72) Inventors: Jia-Hao DU, Xiamen (CN); Jian LI, Shanghai (CN); Ding NING, Shenzhen (CN); Jian-Na SHEN, Xiamen (CN); Yi-Duan SU, Xiamen (CN); Fei-Yang TONG, Xiamen (CN)

(21) Appl. No.: 18/070,654

(22) Filed: Nov. 29, 2022

(30) Foreign Application Priority Data
May 31, 2022 (CN) 202210612846.5

(51) Int. Cl. G06T 11/40; G06T 7/50

(52) U.S. Cl. CPC G06T 11/40; G06T 7/50; G06T 2207/20032

(57) ABSTRACT

A display image filling method includes filling a plurality of first invalid points in disparity image data to generate first image data, and filling a plurality of second invalid points in the first image data to generate second image data. The first invalid points are filled by searching for valid points in the disparity image data according to a first step size, and the second invalid points are filled by searching for the valid points in the first image data according to a second step size, wherein the first step size is smaller than the second step size.

This application claims the benefit of China application Serial No. CN202210612846.5, filed on May 31, 2022, the subject matter of which is incorporated herein by reference.

### BACKGROUND OF THE INVENTION

### Field of the Invention

The present application relates to a disparity image filling method, and more particularly to a disparity image filling method for filling disparity image data by using information of a partially blocked region and an image processing device.

### Description of the Related Art

In common applications, a disparity image can be used for a machine to determine depth information of a certain point in space. A disparity image includes image information generated while an object is captured with multiple cameras from different angles. Due to differences in imaging angles of the multiple cameras, disparity information may be missing from some pixels in a disparity image. In certain applications, the disparity information missed from the pixels is directly filled by means of filtering. However, disparity information obtained from direct filling by filtering may not be accurate enough, such that accuracy of depth information may also be degraded.

### SUMMARY OF THE INVENTION

In some embodiments, it is an object of the present application to provide to a disparity image filling method that fills disparity image data by using information of a partially blocked region and an image processing device, so as to improve drawbacks of the prior art.

In some embodiments, a disparity image filling method includes filling a plurality of first invalid points in disparity image data to generate first image data, and filling a plurality of second invalid points in the first image data to generate second image data. The first invalid points are filled by searching for valid points in the disparity image data according to a first step size, and the second invalid points are filled by searching for the valid points in the first image data according to a second step size, wherein the first step size is smaller than the second step size.

In some embodiments, an image processing device includes a first image filling circuit and a second image filling circuit. The first image filling circuit fills a plurality of first invalid points in disparity image data to generate first image data. The second image filling circuit fills a plurality of second invalid points in the first image data to generate second image data. The first invalid points are filled by searching for valid points in the disparity image data according to a first step size, and the second invalid points are filled by searching for the valid points in the first image data according to a second step size, wherein the first step size is smaller than the second step size.

In some embodiments, a disparity image filling method includes determining whether a plurality of invalid points in first image data are located in a corresponding blocked region between a first blocked region and a second blocked region, and filling corresponding one among the plurality of invalid points according to a plurality of first valid points located in a direction corresponding to the corresponding blocked region in the first image data to generate second image data.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a flowchart of a disparity image filling method according to some embodiments of the present application;

FIG. 2 is an operation schematic diagram of filling a first invalid point in disparity image data according to some embodiments of the present application;

FIG. 3A is a schematic diagram of an image of disparity image data according to some embodiments of the present application;

FIG. 3B is an operation schematic diagram of searching for valid points around a second invalid point in first image data according to some embodiments of the present application;

FIG. 3C is an operation schematic diagram of filling a second invalid point in second image data according to some embodiments of the present application;

FIG. 4A is a schematic diagram of an image processing device according to some embodiments of the present application;

FIG. 4B is a schematic diagram of an image filling circuit in FIG. 4A according to some embodiments of the present application;

FIG. 4C is a schematic diagram of an image filling circuit in FIG. 4A according to some embodiments of the present application;

FIG. 5A is a schematic diagram of a buffer in FIG. 4A according to some embodiments of the present application;

FIG. 5B is a schematic diagram of a data storage scheme of a register in FIG. 5A according to some embodiments of the present application;

FIG. 6A is a schematic diagram of a buffer in FIG. 4A according to some embodiments of the present application; and

FIG. 6B is a schematic diagram of a data arrangement scheme of multiple memories in FIG. 6A according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

In some embodiments, it is an object of the present application to predict, by detecting a blocked region, a pixel missing disparity information in disparity image data, and accordingly filling a data value of the pixel to generate more accurate disparity image data.

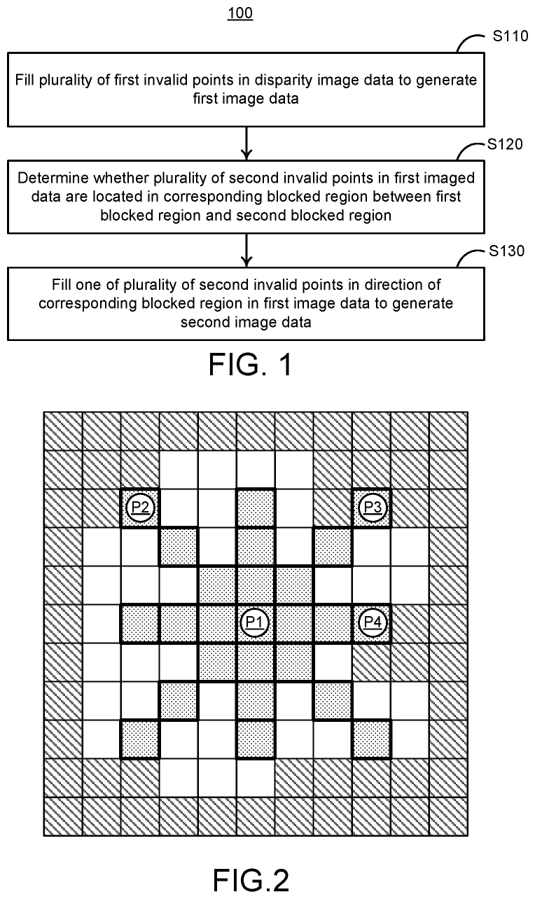

FIG. 1 shows a flowchart of a disparity image filling method 100 according to some embodiments of the present application. In some embodiments, the disparity image filling method 100 can be used to fill a data value of a pixel (to be referred to as an invalid point) missing disparity information in disparity image data. In some embodiments, the disparity image data is image data generated by capturing an object from different directions (for example, front-left and front-right directions) in front of the object by two cameras. For example, the camera on the front-left can capture the object to generate first image data, and the camera on the front-right can capture the object to generate second image data; the disparity image data can be generated according to a difference in imaging positions of the object in the first and second image data. In some applications, the disparity image data can be used to determine a distance between the object and the camera(s).

In operation S110, a plurality of first invalid points in disparity image data are filled to generate the first image data. In some embodiments, data values of a plurality of valid points (that is, pixels having disparity information in the disparity image data) around each of the plurality of first invalid points are used to fill the first invalid points. With the operation above, an invalid region having a smaller area (which may be formed by one or more invalid points) in the disparity image data can be filled, so that the pixel in the invalid region has a certain data value. Related operation details are to be described with reference to FIG. 2 below.

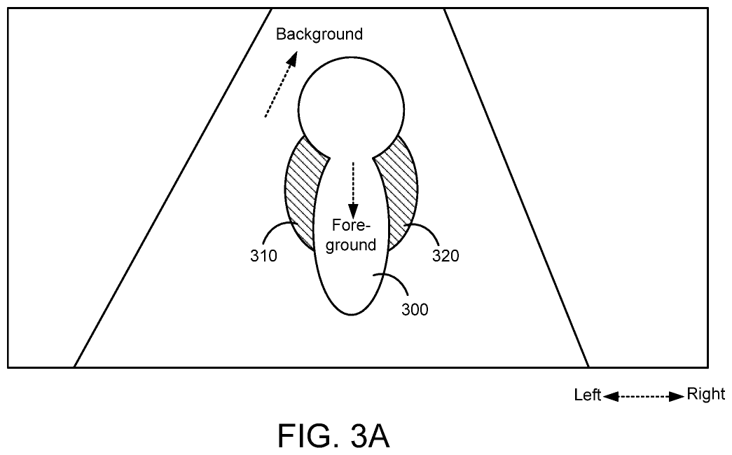

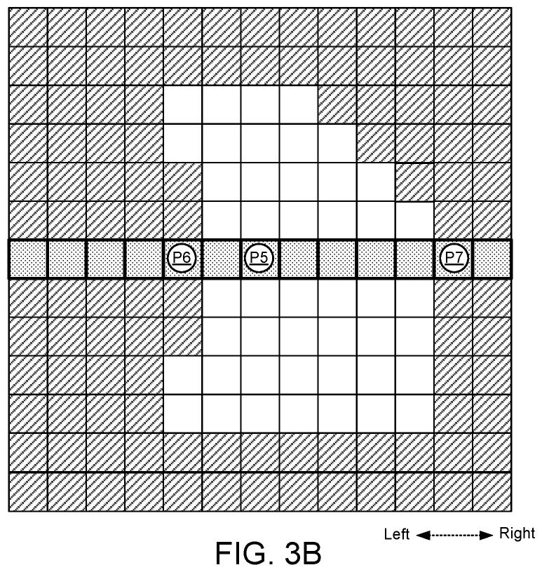

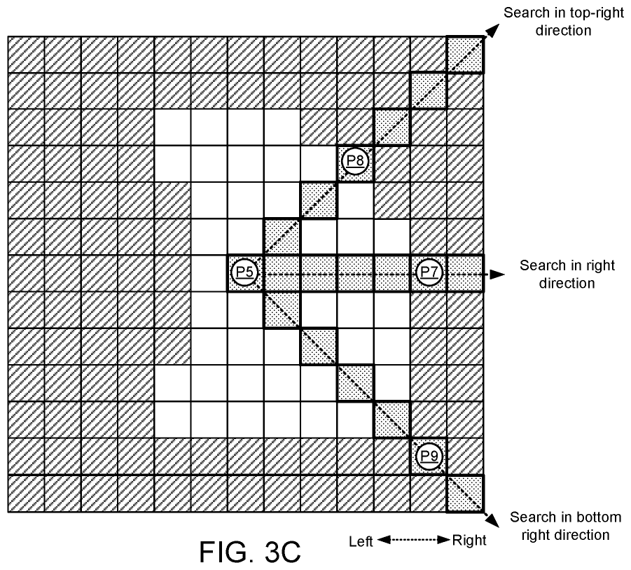

In operation S120, it is determined whether a plurality of second invalid points in the first image data are located in a corresponding blocked region between a first blocked region and a second blocked region. In operation S130, one among the plurality of second invalid points is filled via a plurality of valid points in a direction of the corresponding blocked region in the first image data to generate the second image data. In some embodiments, a blocked region refers to a specific region formed in the disparity image data due to a difference in capturing angles of multiple cameras, and disparity information is missed from the pixels in the specific region (hence a region in which invalid points are formed). With the two operations above, an invalid region having a larger area (that is, a blocked region) in the disparity image data can be filled, so that the pixel in the invalid region has a valid data value. Operation details related to operation S120 and operation S130 above are described with reference to FIG. 3 below.

In some embodiments, the disparity image filling method 100 may further include another operation (not shown). In this operation, the second image data may be filtered (for example, by median filtering) to generate output image data. For example, the data value of the invalid point may be calculated according to numerical values of a plurality of valid points around the invalid point in the second image data. In some embodiments, the numerical values of a plurality of valid points located on top, bottom, left, top-left, bottom-left, right, top-right and bottom-left of the invalid point may be sorted, and a median value among the numerical values of these valid points is used as the data value of the invalid point. Thus, by repeating the steps above, the remaining invalid points in the second image data can be filled, so as to generate the output image data having complete disparity information.

The plurality operations of the disparity image filling method 100 above are merely examples, and are not limited to being performed in the order specified in this example. Without departing from the operation means and ranges of the various embodiments of the present application, additions, replacements, substitutions or omissions may be made to the operations of the disparity image filling method 100, or the operations may be performed in different orders (for example, simultaneously performed or partially simultaneously performed).

FIG. 2 shows an operation schematic diagram of filling a first invalid point in disparity image data according to some embodiments of the present application. The operation in FIG. 2 corresponds to operation S110 in FIG. 1. In FIG. 2, grids with a dotted background represent pixels within a search range, grids with a blank background represent pixels missing disparity information (that is, invalid points), and grids with a line-shaded background represent pixels with disparity information (that is, valid points).

In some embodiments, operation S110 may include four steps. In the first step, valid points located around a first invalid point (for example, an invalid point P1) in the disparity image data are identified. More specifically, the invalid point P1 is configured as the center, searching is performed along left, top-left, top, top-right, right, bottom-left, bottom and bottom-left directions according to a first step size (or to be understood as a search radius) for a nearest valid point. In the example in FIG. 2, the first step size is 3 pixels. the invalid point P1 is configured as the center, valid points P2, P3 and P4 are found sequentially along the top-left, top-right and right directions, and no valid points are found in the remaining directions.

In the second step, if the number of the valid points is greater than or equal to a predetermined value, the first invalid point is filled according to the valid points. In the third step, if the number of the valid points is smaller than the predetermined value, the first invalid point is not filled. For example but not limited to, the predetermined value may be 6. In the example above, the number of the valid points P2 to P4 is less than 6. Thus, in this example, the invalid point P1 is not filled. In some embodiments, if the number of the valid points is greater than or equal to 6, the data value of the invalid point may be set to be a median value among the values of the valid points. In some other embodiments, if the number of the valid points is greater than or equal to 6, a calculation operation can be performed according to the values of the valid points to determine the data value of the invalid point. In the fourth step, the first to third steps are repeated, until all the first invalid points in the disparity image data are fully processed, and the filled disparity image data is output as the first image data.

FIG. 3A shows a schematic diagram of an image of disparity image data according to some embodiments of the present application. As described above, the disparity image data is generated by capturing an object from different directions (for example, front-left and front-right directions) in front of the object by two (or more) cameras. For example, in FIG. 3A, an object 300 is a target that is captured, and a left blocked region 310 and a right blocked region 320 are invalid regions generated by the difference in the capturing angles. For example, the camera (not shown) located on the front-right of the object 300 is blocked by the object 300 and hence is incapable of capturing a specific region on the rear-left of the object, such that disparity information in the specific region is missing from the disparity image data and the left blocked region 310 is formed. Similarly, the camera (not shown) located on the front-left of the object 300 is blocked by the object 300 and hence is incapable of capturing a specific region on the rear-right of the object, such that disparity information in the specific region is missing from the disparity image data and the right blocked region 320 is formed. It should be noted that details of forming of the blocked regions above are merely examples, and the present application is not limited to these examples.

To enhance the prediction accuracy of the disparity information in the left blocked region 310 and the right blocked region 320, in some embodiments, several concepts below are used as a foundation for analyzing contents of the image in FIG. 3A. First of all, the level of correlation of disparity information of a plurality of pixels similarly located in a foreground or a background is higher, and the level of correlation gets higher if the positions of a plurality of pixels get closer to one another. In general, according to a difference in depth, an image may be substantially divided into a foreground and a background. For example, the object 300 itself and an object (if any) before the object 300 are considered to be the foreground, and an object behind the object 300 is considered to be the background. If the positions of two pixels are both located in the foreground (for example, both located on the object 300), it can be deduced that the disparity between these two pixels is rather close. If the positions of two pixels on the object 300 get closer, the disparity information of these two pixels may be the same, hence a higher level of correlation. Moreover, if a pixel is located in a blocked region, the disparity of the pixel is closer to the background. For example, the left blocked region 310 and the right blocked region 320 may be understood as invalid regions formed because an object in the background is not simultaneously captured by the two left and right cameras due to the influences of an object in the foreground. Since the object having been blocked is considered the background, it can be reasonably anticipated that the disparity of the pixels in the left blocked region 310 and the right blocked region 320 is closer to that of the background.

In general, the disparity of a pixel in the foreground is larger and the disparity of a pixel in the background is smaller. Thus, it can be further deduced that, if a difference between the disparity of the nearest valid point on the left of the invalid point and the nearest valid point on the right of the invalid point is greater than or equal to a threshold, it can be determined that the invalid point is located in the right blocked region 320. Conversely, if a difference between the disparity of the nearest valid point on the right of the invalid point and the nearest valid point on the left of the invalid point is greater than or equal to the threshold, it can be determined that the invalid point is located in the left blocked region 310. If the difference between the foregoing disparity is smaller than the threshold, it is determined that the invalid point is not located within the right blocked region 320 or the left blocked region 310. On the basis of the concept above, in some embodiments, the valid point on the left of the pixel in the left blocked region 310 may be used to fill the pixel, and the valid point on the right of the pixel in the right blocked region 320 may be used to fill the pixel. Related operation details are to be described with reference to FIG. 3B below.

FIG. 3B shows an operation schematic diagram of searching for valid points around a second invalid point in first image data according to some embodiments of the present application. The operation in FIG. 3B corresponds to operation S120 in FIG. 1. Similar to FIG. 2, in FIG. 3B, grids with a dotted background represent pixels within a search range, grids with a blank background represent invalid points, and grids with a line-shaded background represent valid points.

In some embodiments, operation S120 may include a plurality of steps below. In the first step, a first valid point is identified in a first direction from corresponding one among a plurality of second invalid points toward the first blocked region. In the second step, a second valid point is identified in a second direction from the corresponding one toward the first blocked region, wherein the first direction and the second direction are opposite directions. For example, as shown in FIG. 3B, the invalid point P5 may be used as a center, and searching is performed in a left direction (that is, the first direction toward the left blocked region 310) for the nearest valid point by using the second step size (6 pixels in this embodiment), and searching is performed in a right direction (that is, the second direction toward the right blocked region 320) for the nearest valid point by using the second step size. With the method above, the valid point P6 (that is, the first valid point) is found on the left of the invalid point P5, and the valid point P7 (that is, the second valid point) is found on the right of the invalid point P5.

In the third step, the first valid point and the second valid point are compared to determine whether the corresponding one among the second invalid points is located in the first blocked region or the second blocked region. For example, whether a difference obtained by subtracting the data value of the valid point P7 from the data value of the valid point P6 is greater than or equal to a threshold may be determined. If the difference is greater than or equal to the threshold, it means that the disparity (that is, the data value) of the valid point P6 is larger and the disparity of the valid point P7 is smaller. Under such conditions, it may be determined that the disparity of the valid point P6 is close to that of the foreground (for example, the valid point P6 may be located on the object 300 in FIG. 3A), and it may be determined that the disparity of the valid point P7 is close to that of the background (for example, the valid point P7 may be located on an object on the rear-left of the object 300 in FIG. 3A), further determining that the valid point P5 is located in the right blocked region 320. Similarly, if a difference obtained by subtracting the data value of the valid point P6 from the data value of the valid point P7 is greater than or equal to the threshold, it may be determined that the invalid point P7 is located in the left blocked region 310. Alternatively, if the difference between the data value of the valid point P6 and the data value of the valid point P7 is smaller than the threshold, it means that the disparity between the valid point P6 and the valid point P7 is very close, and it may then be determined that the invalid point P5 is not located in the left blocked region 310 or the right blocked region 320. In some embodiments, if no valid point is found along the left direction by using the second step size in the second step, it may be determined that the invalid point P5 is located in the right blocked region 320. Similarly, if no valid point is found along the right direction by using the second step size in the second step, it may be determined that the invalid point P5 is located in the left blocked region 310.

FIG. 3C shows an operation schematic diagram of filling a second invalid point in second image data according to some embodiments of the present application. The operation in FIG. 3C corresponds to operation S130 in FIG. 1. Similar to FIG. 3B, in FIG. 3A, grids with a dotted background represent pixels within a search range, grids with a blank background represent invalid points, and grids with a line-shaded background represent valid points.

In some embodiments, operation S130 may include a plurality of steps below. In the first step, a plurality of valid points are identified in a plurality of directions from the corresponding one among the plurality of second invalid points toward the corresponding blocked region (that is, corresponding to the direction of the corresponding blocked region). In the second step, the corresponding one among the second invalid points is filled according to the valid points.

For example, in the example in FIG. 3B, it is determined that the invalid point P5 is located in the right blocked region 320 (that is, the corresponding blocked region) in FIG. 3A. Thus, as shown in FIG. 3C, using the invalid point P5 as a center, a plurality of nearest valid points P7, P8 and P9 are identified in directions toward the right, top-right and bottom-right of the right blocked region 320 by using the second step size. Next, the data values of the plurality of valid points P7, P8 and P9 are sorted, the one with a median value is selected, and the data value of the invalid point P5 is set to be the median value. With the configuration method above, the corresponding blocked region in which the invalid point P5 is located can be determined, and the plurality of valid points P7 to P9 similarly located in the corresponding blocked region are then used to fill the invalid point P5, thereby enhancing the disparity accuracy of the invalid point P5.

In some embodiments, the second step size may be set according to data size of a tile in the second image data, wherein the tile is the data size processed each time. For example, if the data size of the tile is 128×128 (that is, 128×128 pixels are included in each tile), the second step size may be set to be 127, so as to ensure that one complete tile can be searched within each round of searching. In some embodiments, the first step size used in operation S110 may be set to be smaller than the second step size used in operations S120 and S130. With the configuration method above, operation S110 may be used to fill an invalid region having a smaller area, and operation S130 may be used to fill an invalid region having a larger area.

For better understanding, FIG. 3B and FIG. 3C are illustrated by taking filling one invalid point as an example. It should be understood that, by repeating the multiple operations in FIG. 3B and FIG. 3C, most invalid points in the first image data can be filled to generate the second image data. Next, the remaining sporadic invalid points in the second image data can be filled by using an operation such as median filtering so as to generate more complete output image data.

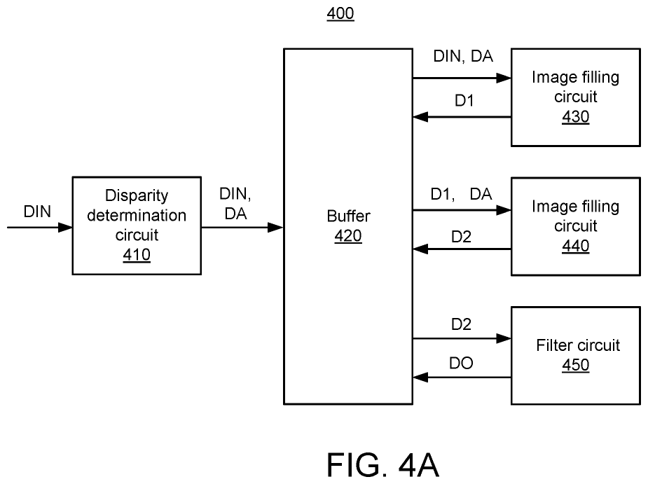

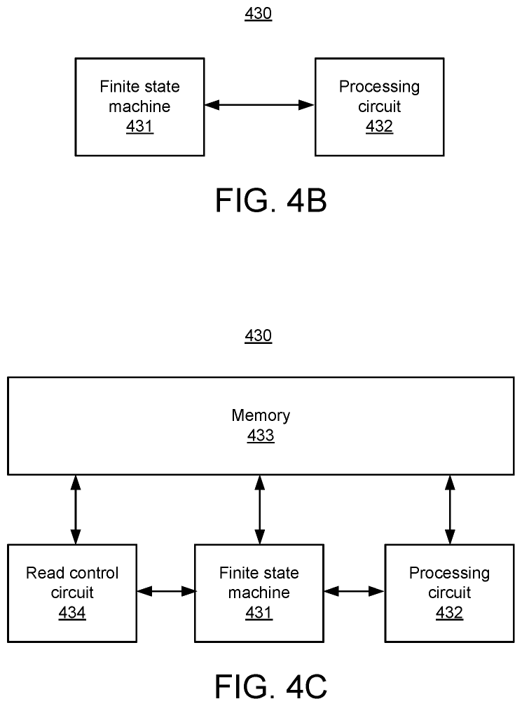

FIG. 4A shows a schematic diagram of an image processing device 400 according to some embodiments of the present application. The image processing device 400 can be used to perform the disparity image filling method 100 in FIG. 1.

The image processing device 400 includes a disparity determination circuit 410, a buffer 420, an image filling circuit 430, an image filling circuit 440 and a filter circuit 450. The disparity determination circuit 410 searches for a plurality of invalid points in disparity image data DIN to generate invalid image data DA. For example, in the disparity image data DIN, data values of valid points may be set to be between 0 to 256 (depending on the disparity), and data values of invalid points may be set to be a predetermined negative value. The disparity determination circuit 410 may sequentially check the data values of all pixels in the disparity image data DIN to label the positions of a plurality of pixels having data values in the predetermined negative value, so as to generate the invalid image data DA. In other words, the invalid image data DA may indicate the positions of the plurality of invalid points in the disparity image data DIN. For example, in the invalid image data DA, the data value of a pixel corresponding to a valid point may be set to logic 1, and the data value of a pixel corresponding to an invalid point may be set to logic 0. As such, a plurality of invalid points in the disparity image data DIN can be quickly identified according to the positions of the plurality of logic values 0.

The buffer 420 stores the disparity image data DIN and the invalid image data DA. The image filling circuit 430 is coupled to the buffer 420, reads at least one of the disparity image data DIN and the invalid image data DA, fills the plurality of invalid points in the disparity image data DIN (that is, corresponding to operation S110 in FIG. 1) to generate image data D1, and stores the image data D1 to the buffer 420. For example, the image filling circuit 430 may determine the positions of the plurality of invalid points according to the data values of a plurality of pixels in the disparity image data DIN, and perform operation S110 to fill the plurality of invalid points so as to generate the image data D1. Alternatively, the image filling circuit 430 may determine the positions of the plurality of invalid points in the disparity image data DIN according to the data values of the invalid image data DA, and perform operation S110 to fill the plurality of invalid points according to the disparity image data DI so as to generate the image data D1. In some embodiments, the image filling circuit 430 may sequentially read the disparity image data DIN and/or the invalid image data DA one tile after another, and sequentially perform operation S110.

The image filling circuit 440 is coupled to the buffer 420, and reads the invalid image data DA and the image data D1. The image filling circuit 440 determines whether the plurality of invalid points in the image data D1 are located in a corresponding blocked region (that is, operation S120 in FIG. 1), fills the plurality of invalid points in the image data D1 according to a plurality of valid points located in a direction of the corresponding blocked region in the image data D1 to generate image data D2 (that is, operation S130 in FIG. 1), and stores the image data D2 to the buffer 420. The filter circuit 450 is coupled to the buffer 420, and reads the image data D2 and performs median filtering on the image data D2 to generate output image data DO.

FIG. 4B shows a schematic diagram of the image filling circuit 430 in FIG. 4A according to some embodiments of the present application. In this example, the image filling circuit 430 may include a finite state machine 431 and a processing circuit 432. The finite state machine 431 may be used to implement a plurality of steps in operation S110. In some embodiments, the processing circuit 432 may include circuits such as an adder, a counter and a comparator so as to compare and sort data. The processing circuit 432 may operate in collaboration with the finite state machine 431, so as to perform operation S110 according to at least one of the disparity image data DIN and/or the invalid image data DA in the buffer 410. In some embodiments, the image filling circuit 430 may sequentially update a plurality of data values in the disparity image data DIN in the buffer 420 and update the invalid image data DA in the buffer 420 according to the plurality of invalid points that have been filled. For example, in an order from left to right and from top to bottom, the plurality of data values in the disparity image data DIN may be updated, the disparity image data DIN is updated to the image data D1, and the invalid image data DA in the buffer 420 is correspondingly updated. In some embodiments, implementation details of the image filling circuit 440 may be similar to those of the configuration method shown in FIG. 4B, and such repeated description is omitted herein.

FIG. 4C shows a schematic diagram of the image filling circuit 430 in FIG. 4A according to some embodiments of the present application. Compared to FIG. 4B, in this example, the image filling circuit 430 may further include a memory 433 and a read control circuit 434. The read control circuit 434 reads the disparity image data DIN in a unit of tiles one after another from the buffer 410 to the memory 433, for the processing circuit 432 and the finite state machine 431 to perform the operation of filling invalid points. In some embodiments, the memory 433 may be implemented by a register. Once the image filling circuit 430 finishes processing one tile (equivalent to a portion of data of the image data D1), the image filling circuit 440 then performs a second round of filling on the processed tile (that is, operations S120 and S130). With the configuration method above, the operation speed of image filling may be further enhanced.

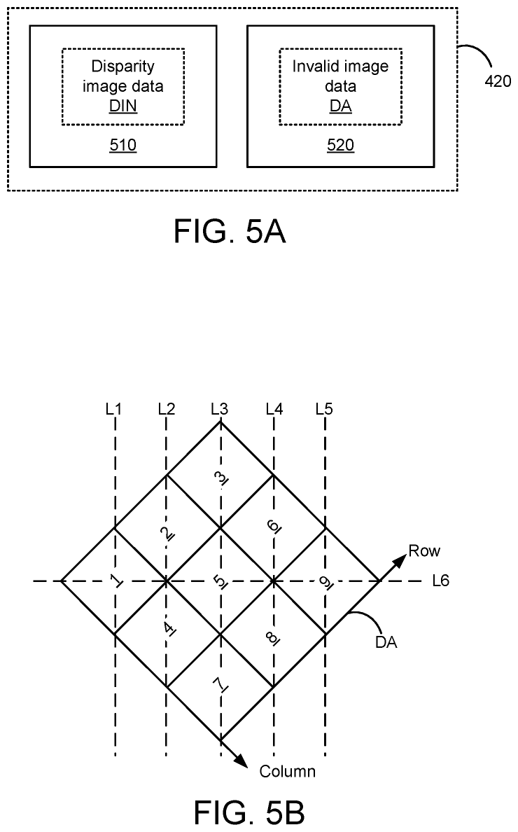

FIG. 5A shows a schematic diagram of the buffer 420 in FIG. 4A according to some embodiments of the present application. In this example, the buffer 420 includes a memory 510 and a register 520. The memory 510 stores the disparity image data DIN, and the register 520 stores the invalid image data DA. In some embodiments, the memory 510 may be, for example but not limited to, a static random access memory (SRAM). The image filling circuit 440 may read the invalid image data DA from the register 520 so as to identify the plurality of valid points in the disparity image data DIN and perform operation S130.

FIG. 5B shows a schematic diagram of a data storage scheme of the register 520 in FIG. 5A according to some embodiments of the present application. As described with reference to FIG. 3B above, once the corresponding blocked region is determined, searching may be performed in a plurality of directions from the invalid point P5 toward the corresponding blocked region for the plurality of valid points, wherein the directions include a horizontal direction (for example, the left direction or the right direction), an oblique direction having a positive slope (for example, the top-right direction or the bottom-left direction), and an oblique direction having a negative slope (for example, the bottom-right direction or the top-left direction). In general, image data is sorted and stored in a row-column manner in a register. However, when searching is to be performed along an oblique direction for valid points, reading a register according to the storage scheme above may require reading data of a plurality of data read lines before values corresponding to individual pixels in this oblique direction can be obtained, and this consumes an immense amount of time. In this example, the data of the invalid image data DA is arranged by way of first being rotated by a certain angle (45 degrees in this example) and then stored in the register 520, such that all pixels in one oblique direction are located on the same data read line of the register 520. Thus, values corresponding to all pixels in one oblique direction can be obtained by reading the same data read line, thereby enhancing searching efficiency in an oblique direction.

More specifically, as shown in FIG. 5B, the invalid image data DA is labeled with logic values corresponding to pixels 1 to 9. The pixels 1 to 9 respectively correspond to a plurality of pixels in first three rows and first three columns in the disparity image data DIN. A plurality of dotted lines L1 to L5 are equivalent to data read lines of the register 520, and the data value corresponding the pixel 1 can be read by reading along the dotted line L1. The data values corresponding the pixel 2 and the pixel 4 can be read by reading along the dotted line L2. The logic values corresponding the pixel 7, the pixel 5 and the pixel 3 can be read by reading along the dotted line L3, and so forth. With the reading method above, it is equivalent to reading data values corresponding to a plurality of pixels in a top-right direction (if the order of reading is opposite, then a bottom-left direction). If the data value is logic 1, it means the pixel is a valid point in the disparity image data DIN. The register 520 can search for the valid points existing in the oblique direction along the oblique direction by using these data read lines, so as to quickly acquire addresses corresponding to these valid points.

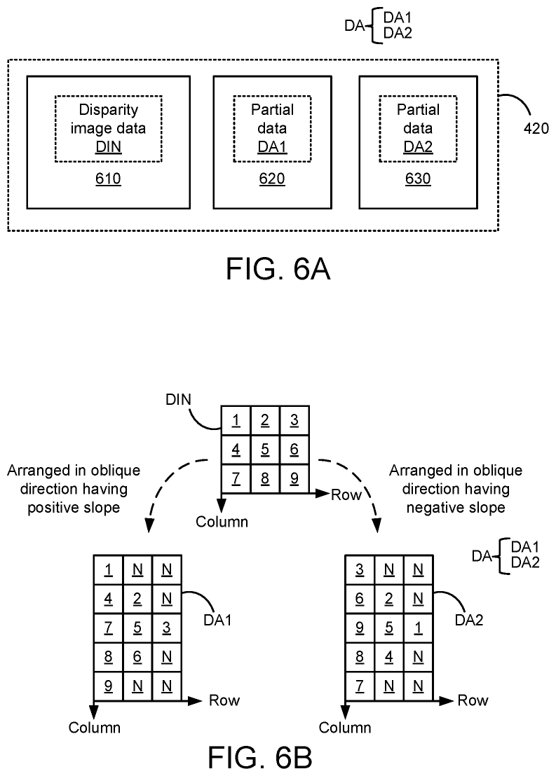

FIG. 6A shows a schematic diagram of the buffer 420 in FIG. 4A according to some embodiments of the present application. In this example, the buffer 420 includes memories 610, 620 and 630. The memory 610 stores the disparity image data DIN. In some embodiments, each of the memories 610, 620 and 630 may be, for example but not limited to, an SRAM. The memory 620 stores partial data DA1 of the invalid image data DA, and the memory 630 stores another partial data DA2 of the invalid data DA. In some embodiments, the partial data DA1 and the partial data DA2 may each include an entirety of the invalid image data D1, with however a storage scheme of the partial data DA1 being different from that of the partial data DA2. The image filling circuit 440 may read the invalid image data DA from the memory 620 and the memory 630 to acquire storage addresses of a plurality of valid points in the disparity image data DIN, so as to identify the valid points and perform operation S130.

FIG. 6B shows a schematic diagram of a data storage scheme of the memories 610, 620 and 630 in FIG. 6A according to some embodiments of the present application. Different from FIG. 5B, in the example in FIG. 6A, each of the memory 620 and the memory 630 may be an SRAM. In general, data is read one row after another and one column after another from an SRAM. If data values of a plurality of pixels in image data are still stored in an original row-column manner in a memory, an immense amount of time is needed to read the memory in order to obtain data values of pixels in a corresponding oblique direction. In this example, the data values of a plurality of pixels labeled in the partial data DA1 are stored to the memory 620 after the invalid image data DA is rearranged in an oblique direction having a positive slope (for example, the top-right direction or the bottom-left direction). As described above, the pixels 1 to 9 respectively correspond to the plurality of pixels in the first three row and the first three columns in the disparity image data DIN. In the memory 620, the data values in the first row sequentially correspond to the pixel 1, a blank point N (equivalent to an invalid point) and a blank point N, the data values in the second row sequentially correspond to the pixel 4, the pixel 2 and a blank point N, and the data values in the third row sequentially correspond to the pixel 7, the pixel 5 and the pixel 3. Accordingly, it is understandable that, if the memory 620 is read one row after another and one column after another, it is equivalent to searching for a plurality of valid points in a top-right direction (if the order of reading is opposite, then a bottom-left direction) As such, labeled data values of a plurality of pixels in the oblique direction having a positive slope can be read from the invalid image data DA from the memory 620.

Similarly, the data values of a plurality of pixels labeled in the partial data DA2 are stored to the memory 630 after the invalid image data DA is rearranged in an oblique direction having a negative slope (for example, the top-left direction or the bottom-right direction). For example, in the memory 630, the data values in the first row sequentially correspond to the pixel 1, a blank point N and a blank point N, the data values in the second row sequentially correspond to the pixel 4, the pixel 2 and a blank point N, and the data values in the third row sequentially correspond to the pixel 7, the pixel 5 and the pixel 3. Accordingly, it is understandable that, if the memory 620 is read one row after another and one column after another, it is equivalent to searching for a plurality of valid points in a top-left direction (if the order of reading is opposite, then a bottom-right direction) As such, labeled data values of a plurality of pixels in the oblique direction having a negative slope can be read from the invalid image data DA from the memory 630.

Compared to FIG. 5B, with the configuration methods in FIG. 6A and FIG. 6B, the number of data read lines can be saved in certain applications, further reducing the overall area of the overall circuit. It should be understood that, FIG. 6B is for illustrating the position correspondence between the data arrangement scheme of the partial data DA1 and DA2 and the plurality of pixels 1 to 9 in the disparity image data, wherein the data values carried in the partial data DA1 and DA2 are for labeling whether the plurality of pixels 1 to 9 in the disparity image data DIN are valid points or invalid points, and the data values carried in the disparity image data DIN are disparity information of the plurality of pixels 1 to 9.

In conclusion, the disparity image filling method and the image processing method according to some embodiments of the present application are capable of filling a pixel missing disparity information in disparity image data by using information of a partially blocked region. Thus, the accuracy of disparity information of the pixel can be enhanced.

While the present application has been described by way of example and in terms of the preferred embodiments, it is to be understood that the present application is not limited thereto. Various modifications made be made to the technical features of the present application by a person skilled in the art on the basis of the explicit or implicitly disclosures of the present application. The scope of the appended claims of the present application therefore should be accorded with the broadest interpretation so as to encompass all such modifications.

What is claimed is:

1. A disparity image filling method, comprising:
filling a plurality of first invalid points in disparity image data to generate first image data; and
filling a plurality of second invalid points in the first image data to generate second image data;
wherein, the first invalid points are filled by searching for valid points in the disparity image data according to a first step size, and the second invalid points are filled by searching for the valid points in the first image data according to a second step size, wherein the first step size is smaller than the second step size.

2. The disparity image filling method according to claim 1, further comprising:
determining whether the plurality of second invalid points in the first image data are located in a corresponding blocked region between a first blocked region and a second blocked region;
wherein, the filling of the plurality of second invalid points in the first image data comprises:
filling corresponding one among the plurality of second invalid points according to a plurality of first valid points in a direction of the corresponding blocked region of the first image data.

3. The disparity image filling method according to claim 2, wherein the determining of whether the plurality of second invalid points in the first image data are located in the corresponding blocked region between the first blocked region and the second blocked region comprises:
identifying a second valid point in a first direction from the corresponding one among the plurality of second invalid points toward the first blocked region;
performing searching in a second direction from the corresponding one toward the second blocked region for a third valid point; and
comparing the second valid point and the third valid point to determine whether the corresponding one is located in the first blocked region or the second blocked region.

4. The disparity image filling method according to claim 3, wherein the first direction and the second direction are opposite to each other.

5. The disparity image filling method according to claim 1, wherein the filling of the plurality of first invalid points in disparity image data to generate the first image data comprises:
identifying a plurality of second valid points located around a first point among the first invalid points from the disparity image data;
if a number of the second valid points is greater than or equal to a predetermined value, filling the first point according to the second valid points; and
if the number of the second valid points is smaller than the predetermined value, not filling the first point.

6. The disparity image filling method according to claim 1, further comprising:
performing median filtering on the second image data to generate output image data.

7. An image processing device, comprising:
a first image filling circuit, filling a plurality of first invalid points in disparity image data to generate first image data; and
a second image filling circuit, filling a plurality of second invalid points in the first image data to generate second image data;
wherein, the first invalid points are filled by searching for valid points in the disparity image data according to a first step size, and the second invalid points are filled by searching for the valid points in the first image data according to a second step size, wherein the first step size is smaller than the second step size.

8. The image processing device according to claim 7, further comprising:
a disparity determination circuit, searching for the plurality of first invalid points in the disparity image data to generate invalid image data; and
a buffer, storing the disparity image data and the invalid image data.

9. The image processing device according to claim 8, wherein the first image filling circuit updates the invalid image data stored in the buffer according to the first image data.

10. The image processing device according to claim 8, wherein the buffer comprises:
a static random access memory (SRAM), storing the disparity image data; and
a register, storing the invalid image data.

11. The image processing device according to claim 10, wherein label values of a plurality of pixels in an oblique direction of the invalid image data are read via a data read line in the register.

12. The image processing device according to claim 10, wherein the second image filling circuit searches for valid points in the first imaged data according to the invalid image data in the buffer.

13. The image processing device according to claim 7, further comprising:
a first memory, storing the disparity image data;
a second memory, storing first data; and
a third memory, storing second data;
wherein, the first data is data is data of invalid image data arranged in a first slope direction, the second image data is data of the invalid image data arranged in a second slope direction, and the invalid image data labels a plurality of invalid points in the disparity image data.

14. A disparity image filling method, comprising:
determining whether a plurality of invalid points in first image data are located in a corresponding blocked region between a first blocked region and a second blocked region; and
filling corresponding one among the plurality of invalid points according to a plurality of first valid points in a direction of the corresponding blocked region in the first image data to generate second image data.

15. The disparity image filling method according to claim 14, wherein the determining of whether the plurality of invalid points in the first image data are located in the corresponding blocked region between the first blocked region and the second blocked region comprises:
identifying a second valid point in a first direction from the corresponding one among the plurality of invalid points toward the first blocked region;
performing searching in a second direction from the corresponding one toward the second blocked region for a third valid point; and
comparing the second valid point and the third valid point to determine whether the corresponding one is located in the first blocked region or the second blocked region.

16. The disparity image filling method according to claim 15, wherein the first direction and the second direction are opposite to each other.

17. The disparity image filling method according to claim 14, wherein the filling corresponding one among the plurality of invalid points according to a plurality of first valid points in a direction of the corresponding blocked region in the first image data to generate second image data comprises:
identifying the plurality of first valid points in a plurality of directions from the corresponding one among a plurality of second invalid points toward the corresponding blocked region, wherein the plurality of second invalid point is identified in a first direction from the corresponding one among the plurality of invalid points toward the first blocked region; and
filling the corresponding one among the plurality of second invalid points according to the data values of the plurality of first valid points.

18. The disparity image filling method according to claim 17, wherein the filling corresponding one among the plurality of second invalid point according to the data values of the plurality of the first valid point comprises:
sorting the data values of the plurality of the first valid points to select one with a median value, and
setting the data value of the corresponding one to be the median value.
